(19) United States
(12) Patent Application Publication
(10) Pub. No.: US 2001/0049700 A1
(43) Pub. Date: Dec. 6, 2001

(54) Information processing apparatus, information processing method and storage medium

(76) Inventor: Shinobu Ichikura, Nei (JP)

Correspondence Address: STAAS & HALSEY LLP, 700 11TH STREET, NW, SUITE 500, WASHINGTON, DC, 20001, US

(21) Appl. No.: 09/766,567

(22) Filed: Jan. 23, 2001

(30) Foreign Application Priority Data
May 26, 2000 (JP) 2000-156440

(51) Int. Cl. G06F 15/00

(52) U.S. Cl. 707/512; 707/513

(57) ABSTRACT

An information processing apparatus has a bookmark registration function for registering a home page which is being inspected. The information processing apparatus includes a keyword extracting section which extracts keywords from contents of a registering home page which is to be registered, and a title adding section which creates a title of the registering home page from the extracted keywords, and adding the title to the registering home page.

### BACKGROUND OF THE INVENTION

This application claims the benefit of a Japanese Patent Application No. 2000-156440 filed May 26, 2000, in the Japanese Patent Office, the disclosure of which is hereby incorporated by reference.

1. Field of the Invention

The present invention generally relates to information processing apparatuses, information processing methods and storage media, and more particularly to an information processing apparatus which has a function of registering an inspection history of an internet home page, an information processing method suited for making a bookmark registration, and to a computer-readable storage medium which stores a program for causing a computer to have such a function.

Recently, popularly used personal computers and electronic apparatuses are provided with various kinds of internet utilizing functions, such as a browser function for inspecting an internet home page by connecting to the internet. In this specification, an “information processing apparatus” generally refers to an apparatus which is provided with such various internet utilizing functions, including desk-top and lap-top personal computers, various electronic apparatuses including portable electronic apparatuses, intelligent telephone sets and intelligent television sets.

2. Description of the Related Art

The browser function which inspects the internal home page (hereinafter simply referred to as home page) by connecting to the internet, generally includes a bookmark function which registers an address (URL) of the inspected home page which is likely to be visited again, as if a “book mark” is inserted in a book.

However, when the home page which is registered by the “bookmark” is inspected again at a later date, it is difficult for the user to effectively and efficiently utilize the registered home page, because the user often forgets the object and reason why the registered home page was previously inspected, and also because the reason or the like the registered home page was inspected is not recorded in the inspection history.

In addition, the title which is automatically added to the home page which is registered by the “bookmark” is generally the character string which is sandwiched between <TITLE> elements of the HTML grammatical rule. For this reason, when the user wishes to revisit the registered home page at a later date, the title of the registered home page which is recorded in the inspection history is in most cases insufficient to make the user recognize the contents of the registered home page.

Furthermore, the registration using the “bookmark” is made with respect to the home page. Consequently, when the user revisits the registered home page at a later date, the user in many situations cannot understand why the user registered the home page and which portions of the home page were of interest to the user.

On the other hand, the home page is often updated periodically. As a result, even if the user registers the home page using the “bookmark” because the user is interested in predetermined information within the home page, the predetermined information may already be changed or deleted when the user next visits the registered home page. In this case, the user cannot obtain the predetermined information the user was interested in even if the user revisits the registered home page which has been updated.

Therefore, according to the conventional registration of the home page using the “bookmark”, it is impossible to know from the inspection history the reason each home page was registered or the contents of each home page. In addition, even if the registered home page is revisited, it may be impossible to obtain the desired information if the registered home page has been updated. Accordingly, there were problems in that it is difficult to effectively and efficiently utilize the inspection history and the registered home page.

Moreover, when registering the home page using the “bookmark”, it is conceivable to manually write information such as the reason for registering the home page and the desired, important or necessary information within the registered home page, and to record the information in correspondence with each registered home page. But according to this conceivable method, it requires the user to write and record the information in correspondence with each registered home page, and the load on the user becomes extremely large because such an operation is time consuming and troublesome to perform.

### SUMMARY OF THE INVENTION

Accordingly, it is a general object of the present invention to provide a novel and useful information processing apparatus, information processing method and computer-readable storage medium, in which the problems described above are eliminated.

Another and more specific object of the present invention is to provide an information processing apparatus and a computer-readable storage medium, which can automatically record information such as a reason for registering a home page, contents of the home page, and desired, important or necessary information within the home page, when registering the home page using the “bookmark” or, when creating or editing the home page, so that it is possible to effectively and efficiently utilize the inspection history and the registered home page.

Still another object of the present invention is to provide an information processing apparatus having a bookmark registration function for registering a home page which is being inspected, comprising a keyword extracting section which extracts keywords from contents of a registering home page which is to be registered, and a title adding section which creates a title of the registering home page from the extracted keywords, and adding the title to the registering home page. According to the information processing apparatus of the present invention, it is possible to automatically record information such as a reason for registering a home page, contents of the home page, and desired, important or necessary information within the home page, when registering the home page using the “bookmark” or, when creating or editing the home page, so that it is possible to effectively and efficiently utilize the inspection history and the registered home page.

A further object of the present invention is to provide a computer-readable storage medium which stores a program for causing a computer to realize a bookmark registration function for registering a home page which is being inspected, where the program comprises a procedure causing the computer to extract keywords from contents of a registering home page which is to be registered, and a procedure causing the computer to create a title of the registering home page from the extracted keywords, and to add the title to the registering home page. According to the computer-readable storage medium of the present invention, it is possible to automatically record information such as a reason for registering a home page, contents of the home page, and desired, important or necessary information within the home page, when registering the home page using the “bookmark” or, when creating or editing the home page, so that it is possible to effectively and efficiently utilize the inspection history and the registered home page.

Another object of the present invention is to provide an information processing apparatus comprising a keyword extracting section extracting keywords from contents of a home page, and a title creating section creating title information of the home page using the extracted keywords. According to the information processing apparatus of the present invention, it is possible to automatically create a title which reflects the contents of the home page, so that a user may easily understand the contents of the home page from the title.

Still another object of the present invention is to provide a computer-readable storage medium which stores a program for causing a computer to realize the processes of extracting keywords from contents of a home page, and creating title information of the home page using the extracted keywords. According to the computer-readable storage medium of the present invention, it is possible to automatically create a title which reflects the contents of the home page, so that a user may easily understand the contents of the home page from the title.

A further object of the present invention is to provide an information processing method for registering a home page which is being inspected, comprising the steps of (a) extracting keywords from contents of a registering home page which is to be registered, and (b) creating a title of the registering home page from the extracted keywords, and adding the title to the registering home page. According to the information processing method of the present invention, it is possible to automatically record information such as a reason for registering a home page, contents of the home page, and desired, important or necessary information within the home page, when registering the home page using the “bookmark” or, when creating or editing the home page, so that it is possible to effectively and efficiently utilize the inspection history and the registered home page.

Another object of the present invention is to provide an information processing method comprising the steps of (a) extracting keywords from contents of a home page, and (b) creating title information of the home page using the extracted keywords. According to the information processing method of the present invention, it is possible to automatically create a title which reflects the contents of the home page, so that a user may easily understand the contents of the home page from the title.

Other objects and further features of the present invention will be apparent from the following detailed description when read in conjunction with the accompanying drawings.

### BRIEF DESCRIPTION OF THE DRAWINGS

FIG. 1 is a perspective view showing a computer system which is applied with the present invention in a first embodiment;

FIG. 2 is a system block diagram showing a construction of an important part within a main body of the computer system;

FIG. 3 is a functional block diagram for explaining an operation of the first embodiment;

FIG. 4 is a flow chart for explaining an operation of an information processing apparatus shown in FIG. 3;

FIG. 5 is a diagram showing a URL specifying image which is displayed on a display section when specifying the URL;

FIG. 6 is a diagram showing a “bookmark registration” specifying image which is displayed on the display section when specifying the “bookmark registration”;

FIG. 7 is a diagram showing a “bookmark registration” list including titles which are added during the “bookmark registration”;

FIG. 8 is a diagram showing a data structure of information stored in an inspection history information storage;

FIG. 9 is a diagram showing a displayed result of the “bookmark registration”;

FIG. 10 is a functional block diagram for explaining an operation of a second embodiment;

FIG. 11 is a flow chart for explaining an operation of an information processing apparatus shown in FIG. 10;

FIG. 12 is a functional block diagram for explaining an operation of a third embodiment;

FIG. 13 is a flow chart for explaining an operation of an information processing apparatus shown in FIG. 12;

FIG. 14 is a functional block diagram for explaining an operation of a fourth embodiment; and

FIG. 15 is a flow chart for explaining an operation of an information processing apparatus shown in FIG. 14.

### DESCRIPTION OF THE PREFERRED EMBODIMENTS

A description will be given of various embodiments of an information processing apparatus according to the present invention, an information processing method according to the present invention, and a computer-readable storage medium according to the present invention, by referring to the drawings.

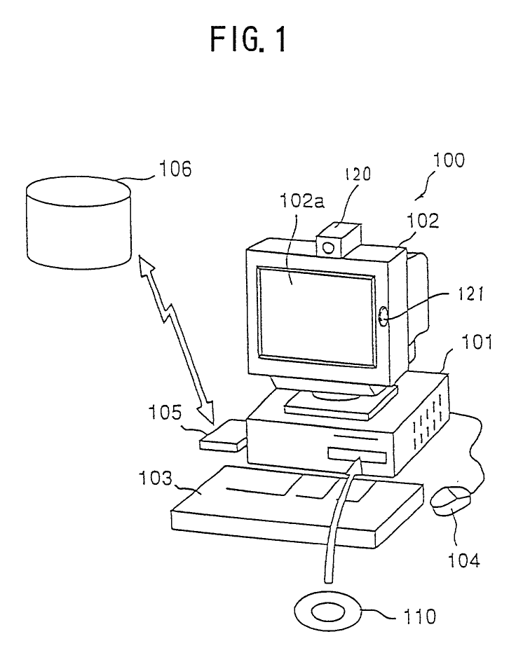

First, a description will be given of a first embodiment of the information processing apparatus according to the present invention. This first embodiment of the information processing apparatus employs a first embodiment of the information processing method according to the present invention and uses a first embodiment of the computer-readable storage medium according to the present invention. In this first embodiment, the present invention is applied to a computer system. FIG. 1 is a perspective view showing the computer system which is applied with the present invention in this first embodiment.

A computer system 100 shown in FIG. 1 is generally provided with a main body 101 which includes a CPU, a disk drive and the like, a display 102 which has a display screen 102a for displaying an image in response to an instruction from the main body 101, a keyboard 103 which is used to input various kinds of information to the computer system 100, a mouse 104 which is used to specify an arbitrary position on the display screen 102a of the display 102, a modem 105 which is used to make access to an external database or the like and to download a program or the like stored in another computer system, an image pickup section 120 which includes a CCD camera or the like, and a speaker 121 which is used to reproduce sound.

A program (software) for causing the computer system 100 to have the internet utilizing functions for connecting the computer system 100 to the internet and receiving various kinds of services, is stored in a portable recording medium such as the disk 110 or, downloaded from a recording medium 106 of another computer system using a communication unit such as the modem 105. The internet utilizing functions include a browser function for inspecting an internet home page.

An embodiment of a computer-readable storage medium according to the present invention is formed by a computer-readable recording medium such as the disk 110 which stores the program described above. The recording medium is not limited to a removable recording medium such as IC card memories, floppy disks, magneto-optical disks, CD-ROMs and various kinds of semiconductor memory devices, and also includes recording media accessible by a computer system which is connected via a communication means or a communication unit such as the modem 105 and a LAN.

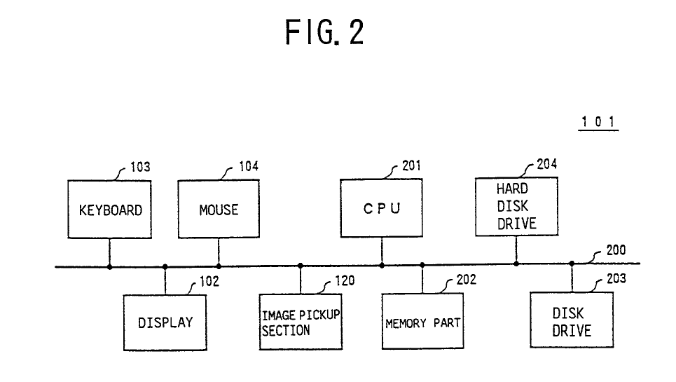

FIG. 2 is a system block diagram showing a construction of an important part within the main body 101 of the computer system 100. In FIG. 2, the main body 101 generally includes a CPU 201, a memory part 202 which is made of a RAM, ROM and the like, a disk drive 203 for the disk 110, and a hard disk drive 204 which are connected via a bus 200. In this embodiment, the display 102, the keyboard 103, the mouse 104 and the image pickup section 120 are connected to the CPU 201 via the bus 200 as shown in FIG. 2, however, each of the display 102, the keyboard 103, the mouse 104 and the image pickup section 120 may be connected directly to the CPU 201. In addition, the display 102 and the image pickup section 120 may be connected to the CPU 201 via a known graphic interface (not shown) which processes input and output image data.

The construction of the computer system 100 is not limited to that shown in FIGS. 1 and 2, and it is of course possible to use various kinds of known constructions instead.

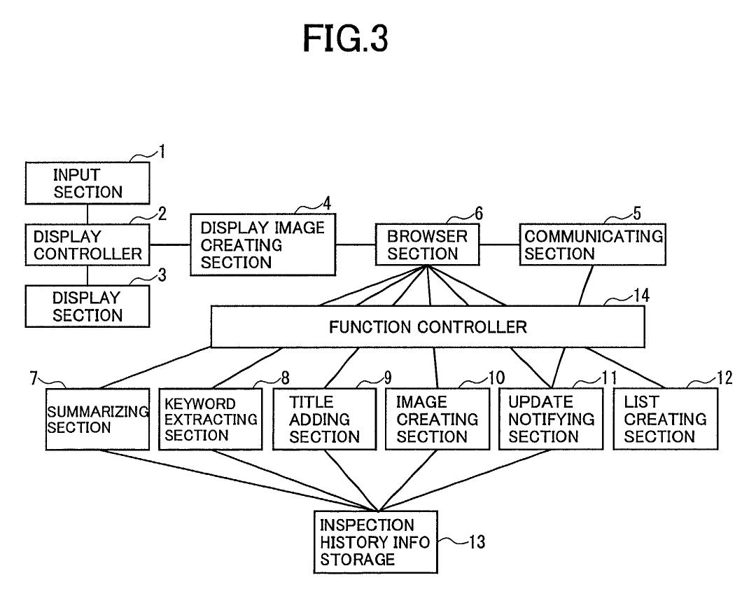

FIG. 3 is a functional block diagram for explaining an operation of this first embodiment. In FIG. 3, the image processing apparatus includes an input section 1, a display controller 2, a display section 3, a display image creating section 4, a communicating section 5, a browser section 6, a summarizing section 7, a keyword extracting section 8, a title adding section 9, an image creating section 10, an update notifying section 11, a list creating section 12, an inspection history information storage 13, and a function controller 14. The input section 1 corresponds to an input device such as the keyboard 103 and the mouse 104. The display section 3 corresponds to the display 102. The communicating section 5 includes a function for communicating with an external server or the like using the modem 105, and is realized by the CPU 201. The display controller 2, the display image creating section 4, the browser section 6, the summarizing section 7, the keyword extracting section 8, the title adding section 9, the image creating section 10, the update notifying section 11, the list creating section 12 and the function controller 14 are realized by the CPU 201 which operates under the program of the present invention and other programs. The inspection history information storage 13 corresponds to a storage unit such as the memory part 202, the disk drive 203 and the hard disk drive 204.

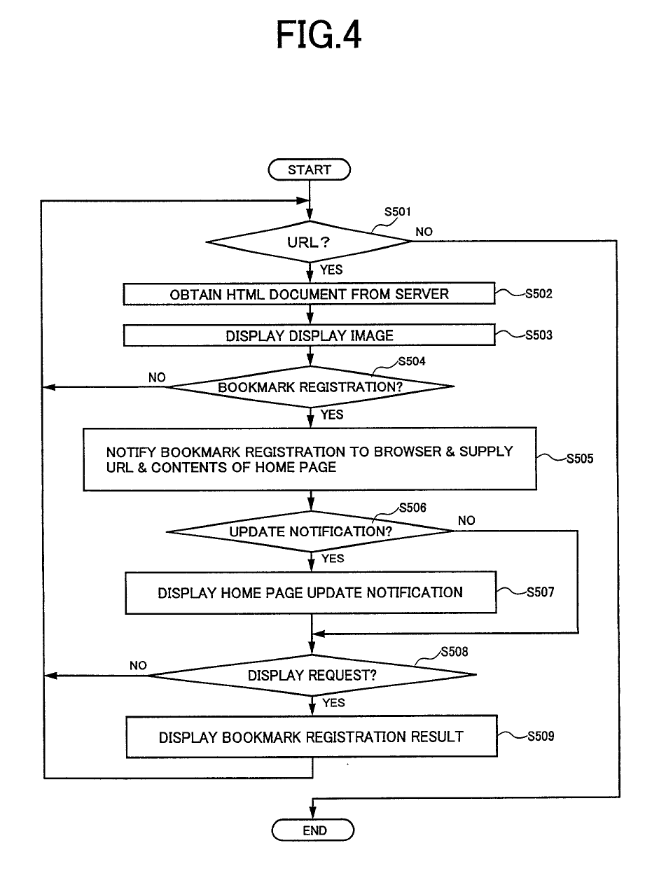

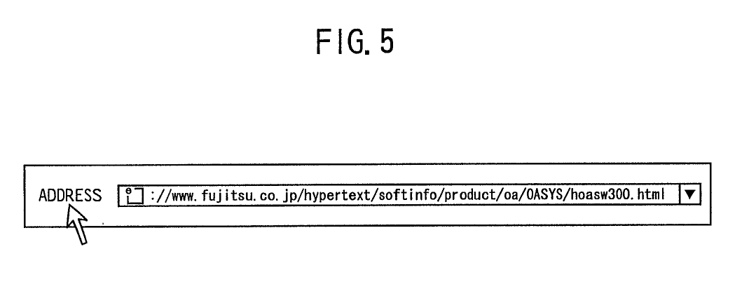

FIG. 4 is a flow chart for explaining an operation of the information processing apparatus shown in FIG. 3. The process shown in FIG. 4 is started when a user wishes to display a home page on the display section 3 and the user specifies a URL of this home page from the input section 1. FIG. 5 is a diagram showing a URL specifying image which is displayed on the display section 3 when specifying the URL. A step S501 monitors the input from the input section 1, and decides whether or not the URL of the home page which is to be displayed is specified. The process ends if the decision result in the step S501 is NO.

If the decision result in the step S501 is YES, the browser section 6 uses the communicating section 5 to communicate with a server which stores the home page corresponding to the specified URL and obtains information of this home page which is to be displayed, in a step S502. The browser section 6 creates a display image by analyzing a HTML document which is obtained, and supplies the display image to the display image creating section 4. The communicating section 5 and the browser section 6 can be realized by known techniques, such as various software program products which are generally marketed. In a step S503, the display image creating section 4 creates the display image from the HTML document, and displays the display image on the display section 3 via the display controller 2.

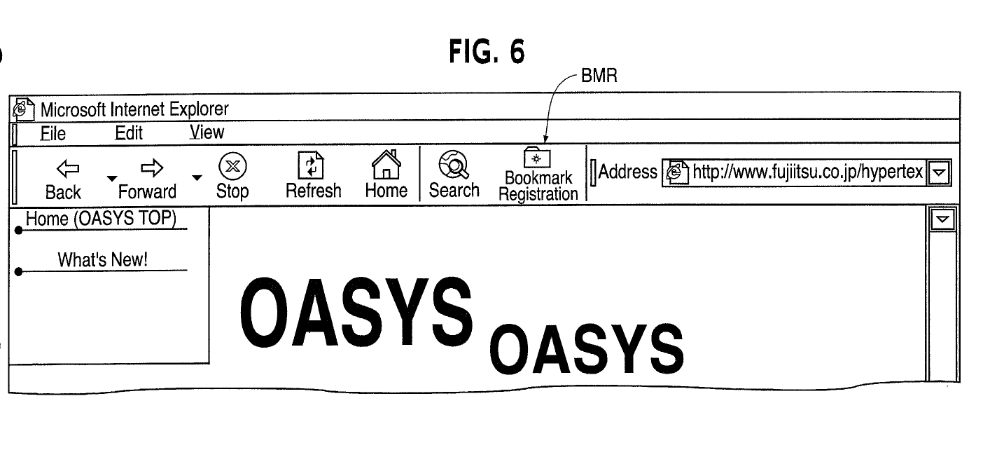

When the user wishes to register the home page which is presently being inspected by use of a “bookmark” (hereinafter simply referred to as a “bookmark registration”), the user specifies the “bookmark registration” from the input section 1. FIG. 6 is a diagram showing a “bookmark registration” specifying image which is displayed on the display section 3 when specifying the “bookmark registration”. In FIG. 6, BMR indicates a “bookmark registration” specifying button. A step S504 decides whether or not the “bookmark registration” is specified, and the process returns to the step S501 if the decision result in the step S504 is NO.

If the decision result in the step S504 is YES, the function controller 14 in a step S505 notifies the browser section 6 that the “bookmark registration” is specified, and supplies the URL and contents of the home page which is presently being displayed on the display section 3 to the summarizing section 7, the keyword extracting section 8, the title adding section 9, the image creating section 10, the update notifying section 11 and the list creating section 12. The summarizing section 7 creates a summary of the contents of the home page which is being inspected, and supplies the summary to the inspection history information storage 13. The keyword extracting section 8 extracts keywords, such as important keywords and frequently appearing keywords, from the contents of the home page which is being inspected, and supplies the extracted keywords to the inspection history information storage 13. The title adding section 9 adds a title of the home page which is being inspected, based on the created summary and the extracted keywords, and supplies the title of the inspection history information storage 13. The image creating section 10 creates a thumbnail of an image of the entire home page which is being inspected, and supplies the image to the inspection history information storage 13. The update notifying section 11 uses the communicating section 5 to periodically check whether or not the home page is updated, and supplies a check result to the inspection history information storage 13. The list creating section 12 creates a list of the URLs such as link information included in the home page which is being inspected, and supplies the list to the inspection history information storage 13.

When creating the summary in the summarizing section 7, it is possible to employ the following known automatic summary creating technique, for example. According to the automatic summary creating technique, the document is analyzed to extract frequently appearing words and phrases and words and phrases used in headings. An importance of a sentence is evaluated depending on an amount of such extracted words and phrases included in the sentence, and the sentences are excerpted in an order of importance. The excerpted sentences are arranged if necessary, by adding conjunctions, particles and the like. A software program which employs such an automatic summary creating technique is employed in-popularly marketed word processing software programs for the Japanese language, including WORD (registered trademark) manufactured by Microsoft Corporation and OASYS (registered trademark) manufactured by Fujitsu Limited. In addition, such word processing software programs employing the automatic summary creating technique are also provided for the English language, including Intelliscope Document Summarizer (registered trademark) manufactured by Lernout & Hauspie Speech Products N.V.

The keyword extracting section 8 extracts, as keywords, the frequently appearing words and phrases from a portion which is sandwiched between <BODY> elements and forms the contents of the home page, and words and phrases which are emphasized by elements such as <HI> and <H2> which indicate headings of the HTML grammatical rule and emphasized by elements such as <B> and <I> which decorate characters. Of course, it is possible to make the keyword extraction so as to also extract a portion sandwiched between <TITLE> elements.

The title adding section 9 creates and adds a title with respect to the home page which is to be subjected to the “bookmark registration”, based on the frequently appearing keyword, for example, among the contents of the created summary and the extracted keywords.

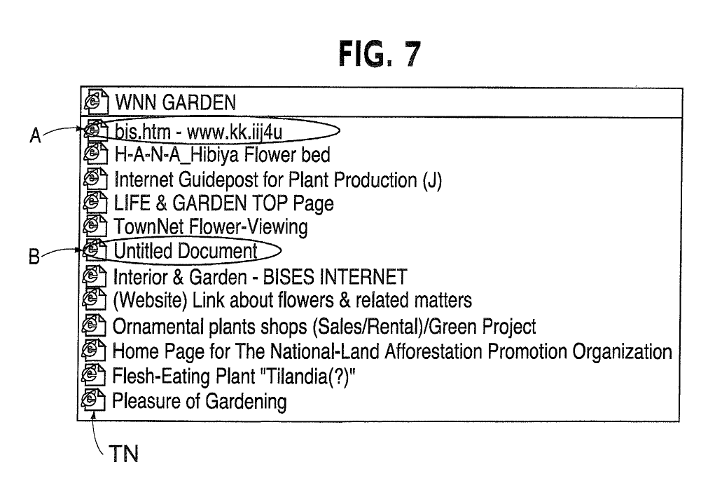

Conventionally, when making the “bookmark registration”, the general browser forcibly uses a character string which is sandwiched between the <TITLE> elements of the HTML grammatical rule as the title which is to be added to the registering home page, as indicated by A and B in FIG. 7. FIG. 7 is a diagram showing a “bookmark registration” list including titles which are added during the “bookmark registration”. The “bookmark registration” list itself is created in the list creating section 12.

On the other hand, in this embodiment, the title which is added to the registering home page is a character string which is based on the summary and the keywords of the contents of the home page. For this reason, when the user again inspects the registered home page at a later date, the user can easily understand the contents and the like of the registered home page from the title which is added to the registered home page. In FIG. 7, the titles added to the home pages when making the conventional “bookmark registration” by the general browser are indicated by A and B for comparison purposes, and all other titles other than A and B in FIG. 7 are the titles added to the home pages according to this embodiment.

The image creating section 10 forms the thumbnail of the image of the entire home page which is to be registered, and displays the thumbnail in the “bookmark registration” list. In FIG. 7, each thumbnail TN shows the image of the entire corresponding home page, and the thumbnail TN is displayed at a position preceding the title of the corresponding home page, for example. Accordingly, when the user searches for a desired registered home page in the “bookmark registration” list, the user can easily and quickly find the desired registered home page because the thumbnails shows the images of the entire registered home pages.

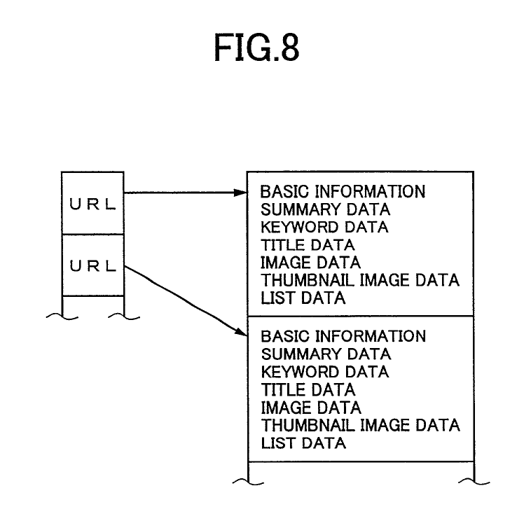

The inspection history information storage 13 stores the information supplied from the summarizing section 7, the keyword extracting section 8, the title adding section 9, the image creating section 10, the update notifying section 11 and the list creating section 12, under a control of the function controller 14. FIG. 8 is a diagram showing a data structure of the information stored in the inspection history information storage 13. As shown in FIG. 8, basic information of the URL from the browser section 6, summary data from the summarizing section 7, keyword data from the keyword extracting section 8, title data from the title adding section 9, thumbnail image data from the image creating section 10, update history data from the update notifying section 11, and “bookmark registration” list data from the list creating section 12 are stored in the inspection history information storage 13, in correspondence with each URL.

Returning now to the description of FIG. 4, the update notifying section 11 decides whether or not a check result indicating an update of a home page is obtained, in a step S506. If the decision result in the step S506 is YES, the update notifying section 11 displays a home page update notification on the display section 3 via the display controller 2, in a step S507. After the step S507 or, if the decision result in the step S506 is NO, the process advances to a step S508 which will be described later. A known technique may be employed for the technique itself for recognizing whether or not a home page of the internet has been updated. Accordingly, such a known technique may be employed when notifying the update of the home page to the update notifying section 11.

The link information included in the home page which is to be subjected to the “bookmark registration” is in many cases related to the same field as the contents of this home page or related to fields which are related to the contents of this home page. For this reason, the link information may be regarded as a collection of URLs having a possibility of being accessed by the user. Accordingly, if the link information is stored and displayed in the form of a list such as a tree structure diagram, a systematic diagram or a table, it facilitates the user to access a home page which handles useful subjects which are interesting to the user.

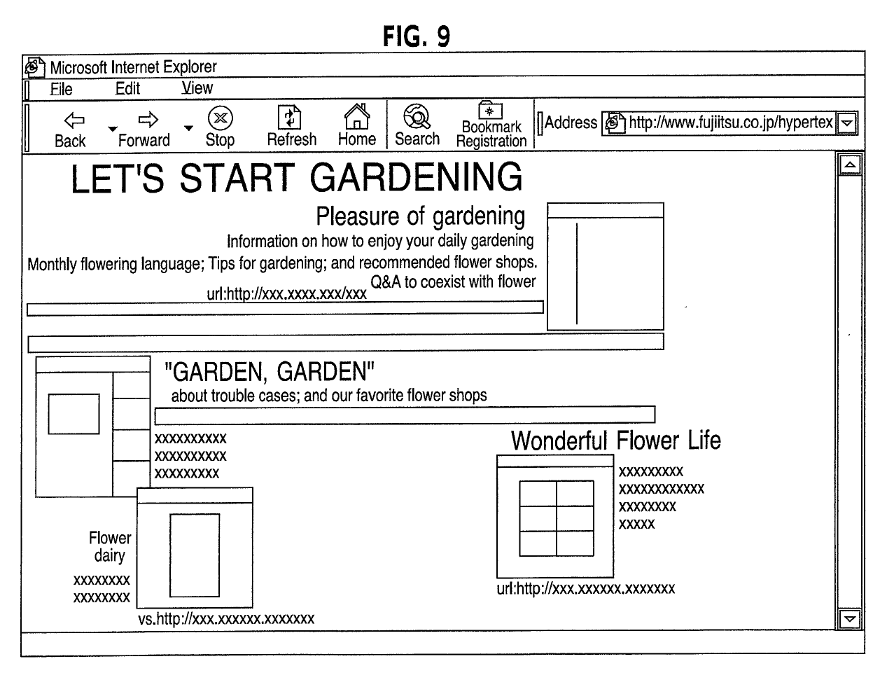

When the user wishes to display the results of the “bookmark registration”, a display request is made to display the “bookmark registration” result from the input section 1. The step S508 monitors the input from the input section 1, and decides whether or not the display request for the “bookmark registration” result is received. The process returns to the step S501 if the decision result in the step S508 is NO. On the other hand, if the decision result in the step S508 is YES, the function controller 14 displays the “bookmark registration” result from the inspection history information storage 13 on the display section 3 via the display controller 2 in a step S509, and the process returns to the step S501. Therefore, a “bookmark registration” result such as that shown in FIG. 9 is displayed on the display section 3.

According to this embodiment, the information of the home page which is subjected to the “bookmark registration” is automatically summarized, analyzed and categorized without the need for the user to be aware of such processes, and for this reason, it is possible to improve the convenience when revisiting the registered home pages. In addition, by creating the thumbnail of the entire home page which is registered by the “bookmark registration”, the thumbnail serves as useful and effective information for helping the user remember the contents and the like of the registered home page when the user wishes to revisit this registered home page. Furthermore, by notifying the update information of the home page which is registered by the “bookmark registration”, it becomes possible to positively and efficiently inspect the contents of the home page the user wishes to visit periodically, for example. Moreover, when the URLs included in the home pages which are registered by the “bookmark registration” are extracted to form a list, the list can be used as a reference when the user wishes to inspect related information of the registered home pages.

Next, a description will be given of a second embodiment of the information processing apparatus according to the present invention. This second embodiment of the information processing apparatus employs a second embodiment of the information processing method according to the present invention and uses a second embodiment of the computer-readable storage medium according to the present invention. In this second embodiment, the present invention is also applied to the computer system shown in FIGS. 1 and 2, similarly as in the case of the first embodiment described above.

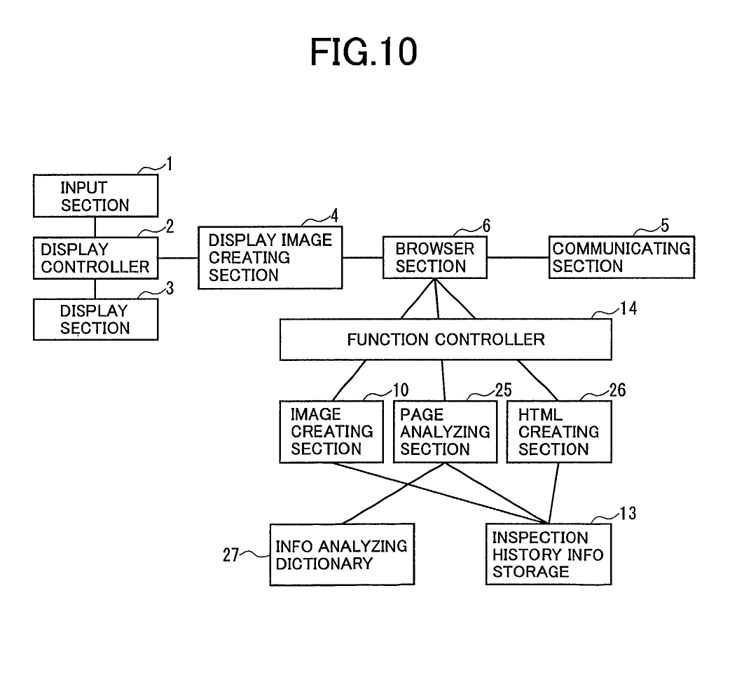

FIG. 10 is a functional block diagram for explaining an operation of this second embodiment. In FIG. 10, those parts which are the same as those corresponding parts in FIG. 3 are designated by the same reference numerals, and a description thereof will be omitted. As shown in FIG. 10, this embodiment is provided with a page analyzing section 25, a HTML creating section 26, and an information analyzing dictionary 27. The page analyzing section 25 analyzes the degree of favorable impression and the like of the user with respect to the home page which is being inspected. The HTML creating section 26 creates and updates a HTML file of the “bookmark registration” information. The information analyzing dictionary 27 is referred to by the page analyzing section 25 when the page analyzing section analyzes the home page which is registered by the “bookmark registration”. Functions of the page analyzing section 25, the HTML creating section 26 and the information analyzing dictionary 27 are realized by the CPU 201.

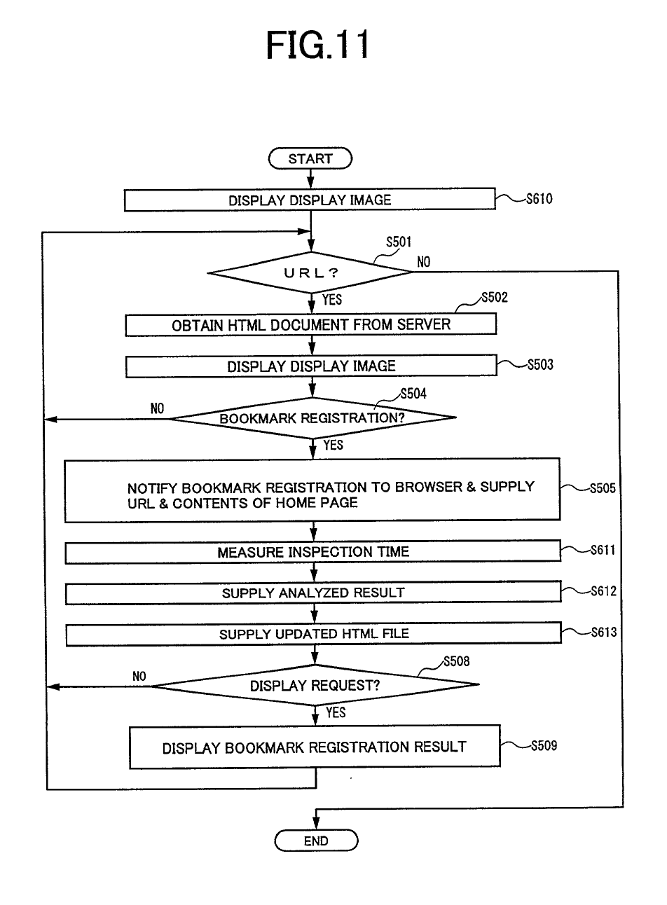

FIG. 11 is a flow chart for explaining an operation of the information processing apparatus shown in FIG. 10. In FIG. 11, those steps which are the same as those corresponding steps in FIG. 4 are designated by the same reference numerals, and a description thereof will be omitted. The second embodiment of the computer-readable storage medium is formed by a recording medium which sores a program for causing the CPU 201 to carry out the process shown in FIG. 11.

When the “bookmark registration” information is stored as in the case of the first embodiment described above, in a step S610 shown in FIG. 11, the function controller 14 supplies the HTML file of the “bookmark registration” information from the inspection history information storage 13 to the display image creating section 4. Hence, the display image created by the display image creating section 4 is displayed on the display section 3 via the display controller 2. After the step S601, the process advances to the step S501. In other words, the user refers to his own “bookmark registration” information in HTML and including the thumbnail of each registered home page, and specifies the URL which is to be displayed from the input section 1.

Generally, when inspecting the home page, there are many cases where the user wishes to revisit the home page he has once visited in the past. Hence, when the list of the “bookmark registration” information in HTML is first displayed as the home page when the browser section 6 is started, it becomes unnecessary for the user to open the “bookmark registration” information list, and the user can make access to the internet from a state where optimum information for the user is displayed.

In this embodiment, after the step S505, steps S611 through S613 shown in FIG. 11 are carried out in place of the steps S506 and S507 shown in FIG. 4, and the process thereafter advances to the step S508. When the user starts inspecting the home page, the page analyzing section 25 measures an inspection time of the home page which is being inspected and supplies the inspection time to the inspection history information storage 13, in the step S611. The page analyzing section 25 judges the degree of favorable impression of the user with respect to the home page based on the inspection time. When this home page is registered by the “bookmark registration”, the page analyzing section 25 changes the order, display format and the like of the URL list of the “bookmark registration” information, and the HTML file is updated in the HTML creasing section 26 at all times.

When the degree of favorable impression of the user with respect to the home page is judged solely depending on the inspection time, it becomes impossible to distinguish a case where the user abandons the information processing apparatus in a state where the access is made to the URL but no inspection is actually made. For this reason, it is desirable to take measures such as not regarding the access to the URL an inspection unless a scroll operation is made within a predetermined time, for example. In the updated “bookmark registration” information list, the URL of the home page having the highest inspection frequency may be arranged and displayed at a most conspicuous position, so as to facilitate the user to make access to the desired home page.

In the step S612, the page analyzing section 25 refers to the information analyzing dictionary 27, and analyzes the field of the home page which is registered by the “bookmark registration”. In addition, the page analyzing section 25 supplies the analyzed result to the inspection history information storage 13.

In the step S613, the HTML creating section 26 updates the HTML file based on the information which is stored by the processes described above, and supplies the updated HTML file to the inspection history information storage 13. The updated HTML file is displayed on the display section 3 with a format which constantly reflects the most recent information, in response to a request from the user. In this case, it is possible to employ a display format which attracts the user's interests, such as displaying on the URL the top three longest inspection times of the user within a predetermined time period, and displaying the inspection field or contents of the home pages, as shown in FIG. 9, to give an impression to the user as if the user were reading the cover page or table of contents of a magazine.

According to this embodiment, the inspection record of the user is created and analyzed as the home pages registered by the “bookmark registration” are accumulated, and the display order and display format of the “bookmark registration” information can be changed so as to make it more convenient for use by the user. In addition, when the user judges the field of interest to the user from the inspection record and notifies the field during inspection of an unknown home page, it is possible to provide a reference for the user to judge the value of the home page which is being inspected. Furthermore, by creating the HTML file from the home pages which are accumulated by the “bookmark registration” and displaying the HTML file when starting the browser, it is possible to quickly display the home page having a high inspection frequency.

Next, a description will be given of a third embodiment of the information processing apparatus according to the present invention. This third embodiment of the information processing apparatus employs a third embodiment of the information processing method according to the present invention and uses a third embodiment of the computer-readable storage medium according to the present invention. In this third embodiment, the present invention is also applied to the computer system shown in FIGS. 1 and 2, similarly as in the case of the first embodiment described above.

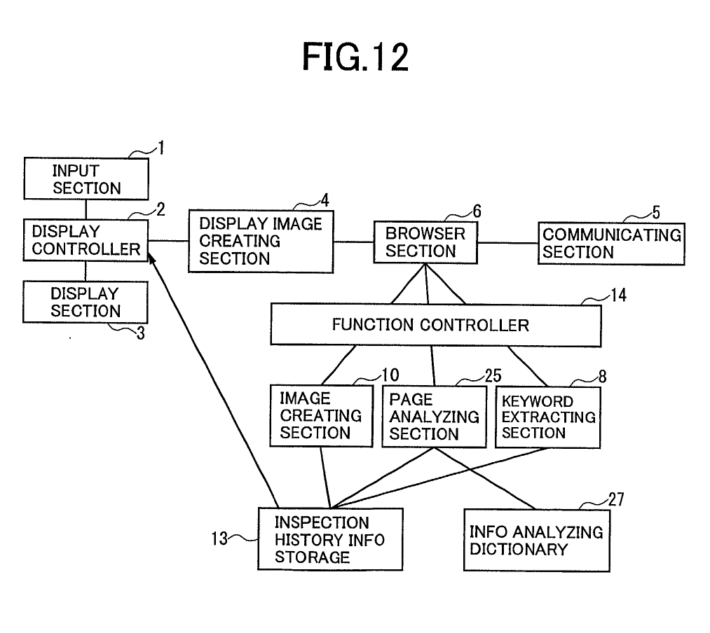

FIG. 12 is a functional block diagram for explaining an operation of this third embodiment. In FIG. 12, those parts which are the same as those corresponding parts in FIGS. 3 and 10 are designated by the same reference numerals, and a description thereof will be omitted.

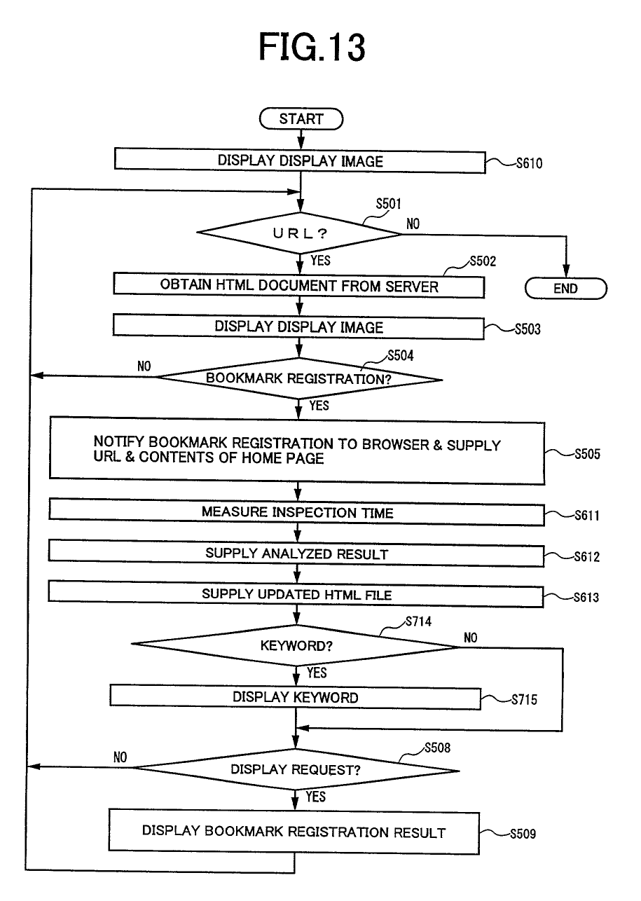

FIG. 13 is a flow chart for explaining an operation of the information processing apparatus shown in FIG. 12. In FIG. 13, those steps which are the same as those corresponding steps in FIG. 11 are designated by the same reference numerals, and a description thereof will be omitted. The third embodiment of the computer-readable storage medium is formed by a recording medium which stores a program for causing the CPU 201 to carry out the process shown in FIG. 13.

In this embodiment, after the step S613, steps S714 and S715 are carried out before the step S508 as shown in FIG. 13. The step S714 decides whether or not the keywords described above in conjunction with the first embodiment exist in the home page which is being inspected by the user. If the decision result in the step S714 is YES, the function controller 14 supplies the information from the inspection history information storage 13 to the display section 3 via the display controller 2 in the step S715. Accordingly, the display section 3 displays information which indicates that the home page is likely the interest of the user, together with the keywords. In this case, the display section 3 may make a blinking display of the character strings of the keywords or change the display color of the character strings of the keywords, so as to make the keywords more conspicuous. As a result, the user can easily recognize whether or not each registered home page is of interest to the user, by simply viewing the display on the display section 3, and the home page of interest to the user can be found easily and quickly.

According to this embodiment, the inspection record of the user is created and analyzed as the home pages registered by the “bookmark registration” are accumulated, and the display order and display format of the “bookmark registration” information can be changed so as to make it more convenient for use by the user. The keywords can also be displayed in a more conspicuous manner. Therefore, the user can easily and quickly recognize whether or not each registered home page includes contents of interest to the user, by looking at the keywords in particular.

Next, a description will be given of a fourth embodiment of the information processing apparatus according to the present invention. This fourth embodiment of the information processing apparatus employs a fourth embodiment of the information processing method according to the present invention and uses a fourth embodiment of the computer-readable storage medium according to the present invention. In this fourth embodiment, the present invention is also applied to the computer system shown in FIGS. 1 and 2, similarly as in the case of the first embodiment described above.

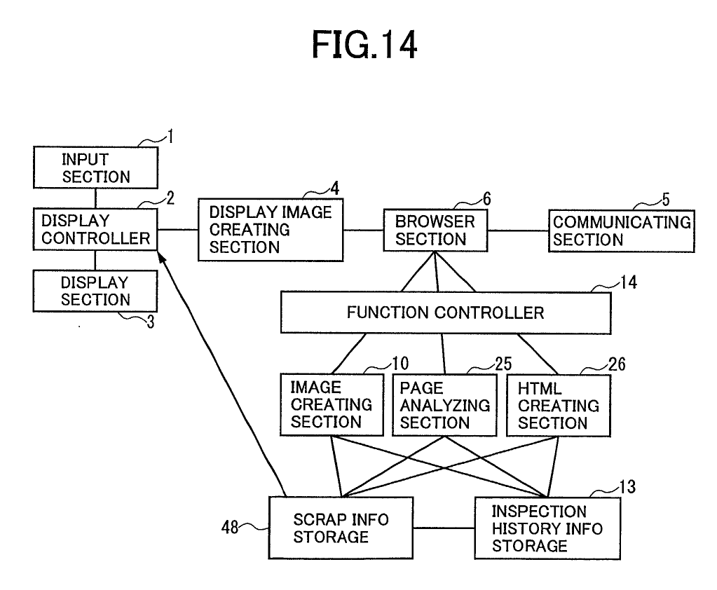

FIG. 14 is a functional block diagram for explaining an operation of this fourth embodiment. In FIG. 14, those parts which are the same as those corresponding parts in FIGS. 3, 10 and 12 are designated by the same reference numerals, and a description thereof will be omitted. In this embodiment, a scrap information storage 48 is provided to store scrap information, as shown in FIG. 14. The scrap information storage 48 corresponds to the memory part 202, the disk drive 203, the hard disk drive 204 or the like.

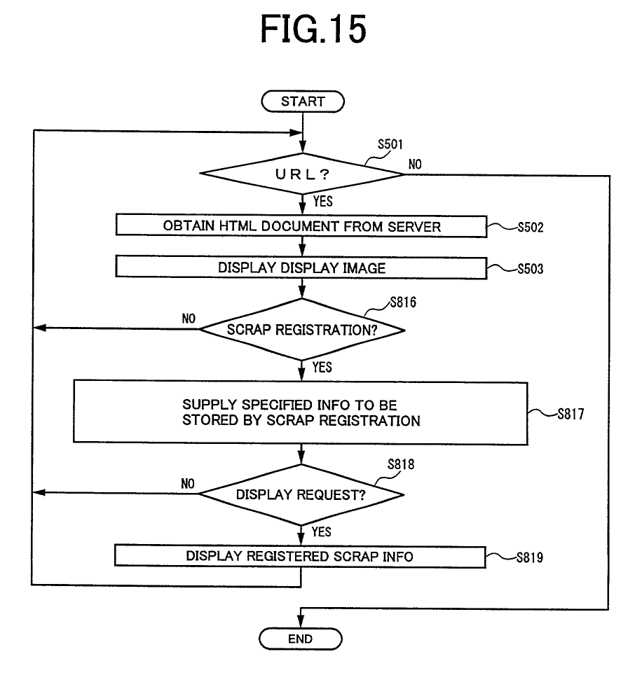

FIG. 15 is a flow chart for explaining an operation of the information processing apparatus shown in FIG. 14. In FIG. 15, those steps which are the same as those corresponding steps in FIG. 4 are designated by the same reference numerals, and a description thereof will be omitted. The fourth embodiment of the computer-readable storage medium is formed by a recording medium which stores a program for causing the CPU 201 to carry out the process shown in FIG. 15.

In this embodiment, steps S816 through S819 are carried out after the step S503. When the user wishes to store only a portion of the home page which is being inspected, the user makes a scrap registration request from the input section 1 to specify the information which is to be stored. The step S816 decides whether or not the scrap registration request is received, and the process returns to the step S501 if the decision result in the step S816 is NO. On the other hand, if the decision result in the step S816 is YES, the step S817 supplies the specified information which is to be stored by the scrap registration to the image creating section 10, the page analyzing section 25 and the HTML creating section 26. In addition, the step S817 also supplies operation results of each of the image creating section 10, the page analyzing section 25 and the HTML creating section 26 to the scrap information storage 48 with a format which does not alter the layout of the home page which is being inspected.

When the user wishes to refer to the scrap information, the user makes a scrap registration result display request from the input section 1. The step S818 decides whether or not the scrap registration result display request is received, and the process returns to the step S501 if the decision result in the step S818 is NO. On the other hand, if the decision result in the step S818 is YES, the step S819 supplies the scrap information from the scrap information storage 48 to the display section 3 via the display controller 2, so as to display the registered scrap information such as that shown in FIG. 9. After the step S819, the process returns to the step S501.

Therefore, a scrapbook or a scrap collection of the information the user wishes to store is created, as if newspaper cuttings are made. When the “bookmark registration” is simply carried out, there is no guarantee that the required information can be retrieved after the home page itself is updated or even deleted. But when the scrapbook or scrap collection is created as in this embodiment, it is possible to always store the required information in a retrievable manner, regardless of whether the required information of the home page is later updated or deleted.

Known techniques may be employed to store the scrap information in the scrap information storage 48. For example, it is possible to analyze the HTML grammatical rule of the home page with respect to which the scrap registration request is made, and to copy the source so as not to alter the layout and additionally write the necessary grammar.

According to this embodiment, it is possible to register not only the entire home page, but also to register only the required portions of the home page, so that the required information can be collected efficiently and the contents of the original home page can be stored in a manner retrievable even after the home page itself is updated.

In each of the embodiments described above, the title of the home page is created by the process of the present invention, when registering the home page which is being inspected by the “bookmark registration” function. However, the present invention is not limited to such a process. For example, it is possible to extract the keywords and to create the title with respect to the contents of the created home page in an editor which creates and edits the home page (HTML file). In this case, it is also possible to create the title which helps the user recognize the contents of the home page.

Further, the present invention is not limited to these embodiments, but various variations and modifications may be made without departing from the scope of the present invention.

What is claimed is:

1. An information processing apparatus having a bookmark registration function for registering a home page which is being inspected, comprising:
a keyword extracting section which extracts keywords from contents of a registering home page which is to be registered; and
a title adding section which creates a title of the registering home page from the extracted keywords, and adding the title to the registering home page.

2. The information processing apparatus as claimed in claim 1, further comprising:
an image creating section which creates a thumbnail of a display image of the registering home page in its entirely.

3. The information processing apparatus as claimed in claim 1, further comprising:
a summarizing section which creates a summary of the contents of the registering home page from the contents of the registering home page.

4. The information processing apparatus as claimed in claim 1, further comprising:
a list creating section which creates a list of URLs of linking destinations included in the registering home page.

5. The information processing apparatus as claimed in claim 1, further comprising:
a page analyzing section which analyzes an inspection record of home pages to obtain an analyzed result, and outputs information of a home page which is being inspected with a display order or display format dependent on the analyzed result.

6. The information processing apparatus as claimed in claim 1, further comprising:
a HTML creating section which creates a HTML file and outputs the HTML file when starting a browser, so as to output a home page having a high inspection frequency with a priority over others based on an inspection record of home pages.

7. The information processing apparatus as claimed in claim 1, further comprising:
a scrap information storage which stores an arbitrary specified portion of the registering home page.

8. A computer-readable storage medium which stores a program for causing a computer to realize a bookmark registration function for registering a home page which is being inspected, said program comprising:
a procedure causing the computer to extract keywords from contents of a registering home page which is to be registered; and
a procedure causing the computer to create a title of the registering home page from the extracted keywords, and to add the title to the registering home page.

9. The computer-readable storage medium as claimed in claim 8, wherein said program further comprises a procedure causing the computer to create a thumbnail of a display image of the registering home page in its entirely.

10. The computer-readable storage medium as claimed in claim 8, wherein said program further comprises a procedure causing the computer to create a summary of the contents of the registering home page from the contents of the registering home page.

11. The computer-readable storage medium as claimed in claim 8, wherein said program further comprises a procedure causing the computer to create a list of URLs of linking destinations included in the registering home page.

12. An information processing apparatus comprising:
a keyword extracting section extracting keywords from contents of a home page; and
a title creating section creating title information of the home page using the extracted keywords.

13. A computer-readable storage medium which stores a program for causing a computer to realize the processes of:
extracting keywords from contents of a home page; and
creating title information of the home page using the extracted keywords.

14. An information processing method for registering a home page which is being inspected, comprising the steps of:
(a) extracting keywords from contents of a registering home page which is to be registered; and
(b) creating a title of the registering home page from the extracted keywords, and adding the title to the registering home page.

15. The information processing method as claimed in claim 14, further comprising the step of:
(c) creating a thumbnail of a display image of the registering home page in its entirely.

16. The information processing method as claimed in claim 14, further comprising the step of:
(c) creating a summary of the contents of the registering home page from the contents of the registering home page.

17. The information processing method as claimed in claim 14, further comprising the step of:
(c) creating a list of URLs of linking destinations included in the registering home page.

18. An information processing method comprising the steps of:
(a) extracting keywords from contents of a home page; and
(b) creating title information of the home page using the extracted keywords.
